(19) United States
(12) Patent Application Publication
(10) Pub. No.: US 2006/0130595 A1
(43) Pub. Date: Jun. 22, 2006

(54) Multi axis load cell body

(75) Inventors: Richard A. Meyer, Chaska, MN (US); Alan J. Kempainen, Waconia, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: MTS Systems Corporation

(21) Appl. No.: 11/286,697

(22) Filed: Nov. 23, 2005

Related U.S. Application Data
(60) Provisional application No. 60/630,488, filed on Nov. 23, 2004.

(51) Int. Cl. G01D 7/00

(52) U.S. Cl. 73/862.041

(57) ABSTRACT

A load cell body for transmitting forces and moments in a plurality of directions includes an integral assembly having a first ring member and a second ring member. Each ring member has a central aperture centered on a reference axis. In one embodiment, three or more sensor assemblies extend from the first ring member to the second ring member parallel to the reference axis. Each sensor assembly includes a stiff member attached to one of the rings and extending therefrom to the other radially from the reference axis, and a flexure assembly joining a remote end of each member to the other ring member.

### CROSS-REFERENCE TO RELATED APPLICATION

The present application is based on and claims the benefit of U.S. provisional patent application Ser. No. 60/630,488, filed Nov. 23, 2004 the contents of which is hereby incorporated by reference in its entirety.

### BACKGROUND OF THE INVENTION

The discussion below is merely provided for general background information and is not intended to be used as an aid in determining the scope of the claimed subject matter.

The present disclosure relates to a load cell that transmits and measures linear forces along and moments about three orthogonal axes. More particularly, a compact load cell body that can be used, for instance, as a wheel force transducer among other applications is disclosed.

Wheel force transducer or load cells for measuring forces along or moments about three orthogonal axes are known. The wheel force transducer typically is mounted between and to a vehicle spindle and a portion of a vehicle rim. The transducer measures forces and moments reacted through a wheel assembly at the spindle as the vehicle is operated.

Wheel force transducers that have enjoyed substantial success and critical acclaim are sold under the trade designation Swift® and Swift® 50 transducers by MTS Systems Corporation of Eden Prairie, Minn. and are described in detail in U.S. Pat. Nos. 5,969,268, 6,038,933, and 6,769,312. Generally, these transducers include a load cell body having a plurality of tubular members. A plurality of sensing circuits are mounted to the plurality of tubular members. The load cell body is attached to a vehicle wheel. An encoder measures the angular position of the load cell body allowing the forces transmitted through the radial tubular members to be resolved with respect to an orthogonal stationary coordinate system.

### SUMMARY OF THE INVENTION

This Summary and Abstract are provided to introduce some concepts in a simplified form that are further described below in the Detailed Description. This Summary and Abstract are not intended to identify key features or essential features of the claimed subject matter, nor is it intended to be used as an aid in determining the scope of the claimed subject matter. In addition, the description herein provided and the claimed subject matter should not be interpreted as being directed to addressing any of the short-comings discussed in the Background.

In one embodiment, a load cell is provided that is suitable for transmitting forces and moments in a plurality of directions. The load cell is an integral assembly being formed from a single unitary body and includes a first ring member and a second ring member, each ring member having a central aperture centered on a reference axis. At least three sensor assemblies are included. Each sensor assembly comprises a stiff member attached to one of the rings and extending therefrom to the other radially from the reference axis, and a flexure assembly joining a remote end of each member to the other ring member. Sensing devices are disposed on each of the flexure assemblies configured to sense strain therein.

### BRIEF DESCRIPTION OF THE DRAWINGS

FIG. 1 is a top plan view of a load cell body with portions removed in accordance with the present disclosure.

FIG. 2 is a side elevational view of the load cell body illustrated in FIG. 1.

FIG. 3A is an illustration showing location of sensing devices referenced to various portions of the load cell body.

FIG. 3B is a sectional view taken along lines A-A in FIG. 3A.

FIG. 3C is a sectional view taken along lines B-B in FIG. 3A.

FIG. 4 is a schematic drawing of electrical circuits used to measure forces and moments about an orthogonal coordinate system.

FIG. 5 is a side sectional view of the load cell mounted to a tire rim.

FIG. 6 is a front elevational view of the load cell mounted to the tire rim of FIG. 5.

FIG. 7 is a general block diagram of a controller.

FIG. 8 is a block diagram of a scaling and geometric transformation circuit.

FIG. 9 is a circuit diagram of a portion of a cross coupling matrix circuit.

FIG. 10 is a block diagram of a coordinate transformation circuit.

FIG. 11 is a side sectional view of the load cell mounted to a dual-wheel assembly.

FIG. 12 is a front elevational view of the load cell mounted to the dual-wheel assembly of FIG. 11.

FIG. 13 is a top plan view of a second embodiment of a load cell body with portions removed in accordance with the present disclosure.

FIG. 14 is a side elevational view of the load cell body illustrated in FIG. 1.

FIGS. 15A, 15B and 15C illustrate sensing devices referenced to various portions of the load cell body.

FIGS. 16A, 16B and 16C illustrate a second embodiment of sensing devices referenced to various portions of the load cell body.

FIG. 17 is a schematic drawing of electrical circuits used for the sensing devices of FIGS. 15A, 15B and 15C, or FIGS. 16A, 16B or 16C.

### DETAILED DESCRIPTION OF THE ILLUSTRATIVE EMBODIMENTS

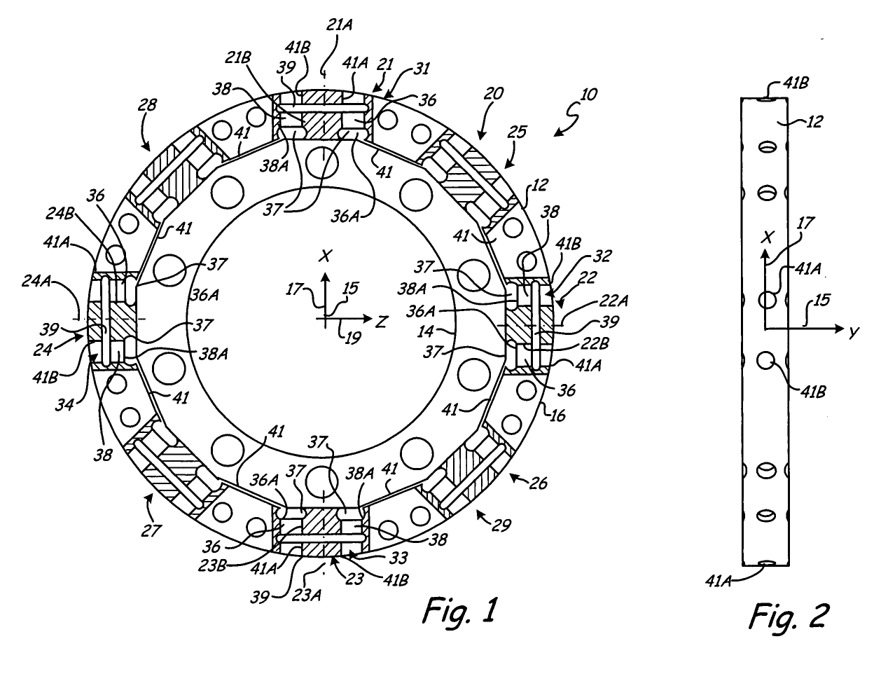

FIGS. 1 and 2 illustrate an embodiment of a load cell 10 of the present disclosure. The load cell 10 preferably includes an integral body 12 fabricated from a single block of material. The load cell body 12 can be manufactured from aluminum, titanium, 4340 steel, 17-4, 15-5 pH stainless steel or other high-strength materials and combinations thereof. The body 12 includes a first rigid annular ring 14 and a second annular ring 16 that is concentric and aligned with the first annular ring 14 so as to be centered about a common axis 15.

A plurality of sensor assemblies 20 join the first annular ring 14 to the second annular ring 16. In the embodiment illustrated, the plurality of sensor assemblies 20 include four assemblies 21, 22, 23 and 24. Each of the assemblies 21-24 extends from the first annular ring 14 to the second annular ring 16. In the embodiment illustrated, assemblies 25, 26, 27 and 28 (collectively indicated as 29) are constructed similar to assemblies 21, 22, 23 and 24 and help distribute the load between rings 14 and 16. Although illustrated wherein the plurality of sensor assemblies 20 and assemblies 29 equals eight, it should be understood that any number of sensor assemblies 20 three or more can be used between the first annular ring 14 to the second annular ring 16 with or without any number of additional load carrying assemblies 29. In the embodiment illustrated, the plurality of sensor assemblies 20 and 29 are spaced at substantially equal angular intervals about the axis 15.

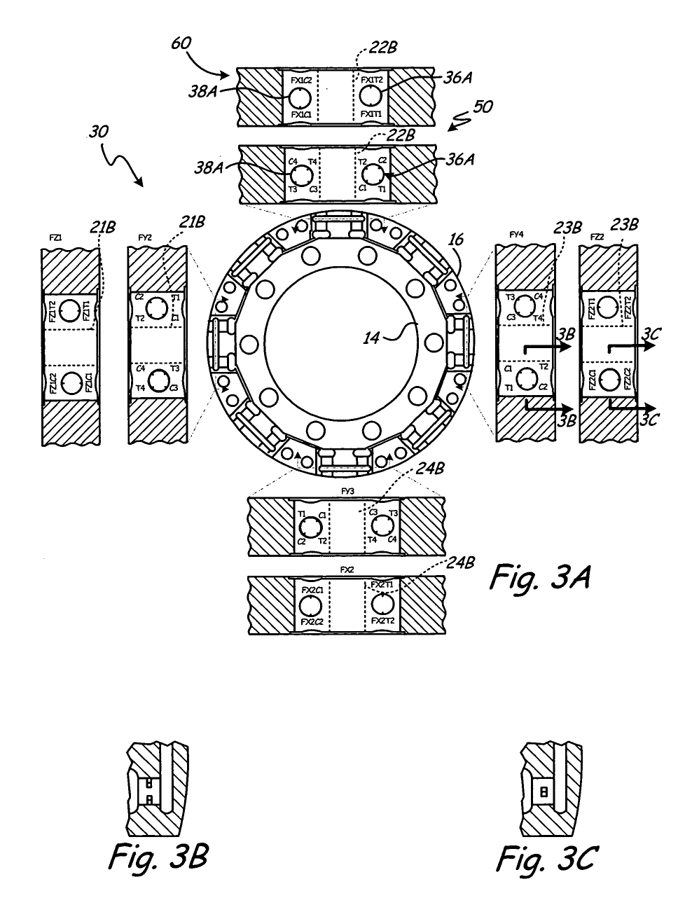

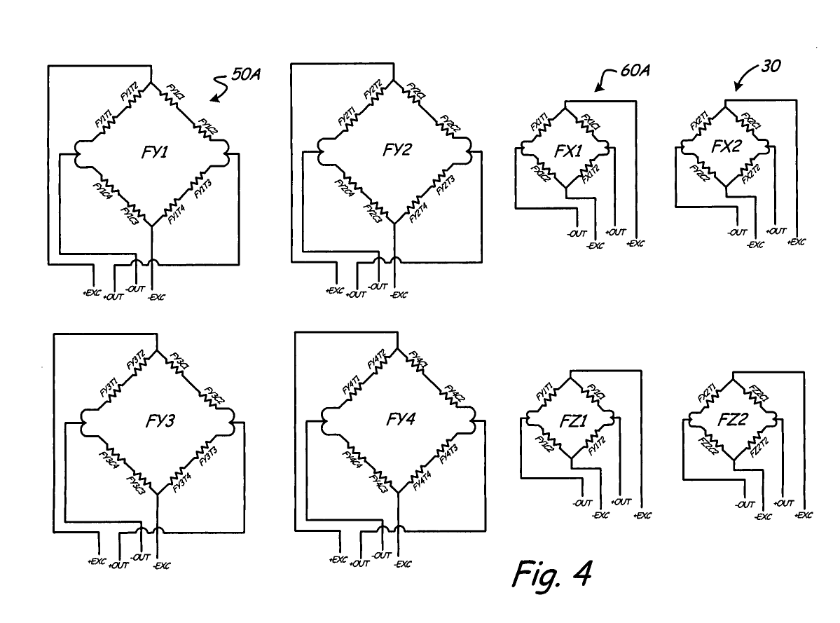

Referring to FIGS. 3A, 3B, 3C and 4, a plurality of sensors 30 are mounted on the plurality sensor assemblies 20 to sense stresses or strain. In the embodiment illustrated, the sensors 30 are strain gauges and are incorporated in a plurality of Wheatstone bridges. Eight Wheatstone bridges are shown in the present example, the configuration of which is but one exemplary configuration in that other configurations can be used as appreciated by those skilled in the art. The Wheatstone bridges are combined so as to provide sensor signals that are provided as outputs from the load cell 10. Assemblies 25, 26, 27 and 28 although constructed similar to assemblies 21, 22, 23 and 24 and help distribute the load between rings 14 and 16 in the embodiment illustrated do not include sensors, but could be so equipped if desired, particularly if signal modulation due to rotation of the load cell 10 while in use is of a concern.

In the example shown, the eight Wheatstone bridges provide eight sensor signals. For purposes of explanation, an orthogonal coordinate system can be defined wherein an X-axis is indicated at 17, a Z-axis is indicated at 19, and a Y-axis corresponds to the central axis 15 (FIGS. 1 and 2). The sensor signals from the load cell 10, as explained below, are used to calculate forces along and moments about the X-axis 17, the Y-axis 15 and the Z-axis 19.

Each of the sensor assemblies 20 includes the same general construction. A plurality of radial members 21B, 22B, 23B and 24B join the central hub 14 to the annular ring 16. The radial members 21B-24B of sensor assemblies 20, and assemblies 29 if present, are stiff, i.e., non-compliant in order to transfer all loads to the between the rings 14 and 16. In the embodiment illustrated, the plurality of radial members 21B, 22B, 23B and 24B are solid and generally rectangular in cross-section at least in part (although the shape may not be that important) and extend radially from the central hub 14 toward the annular ring 16 along a corresponding longitudinal axis 21A, 22A, 23A and 24A. Preferably, axis 21A is aligned with axis 23A, while axis 22A is aligned with axis 24A. In addition, axes 21A and 23A are perpendicular to axes 22A and 24A.

Flexure members 31, 32, 33 and 34 join an end of each radial member 21B, 22B, 23B and 24B, respectively, to the annular ring 16. The flexure members 31-34 are compliant for displacements of each corresponding radial member 21B-24B along the corresponding longitudinal axes 21A-24A. In the embodiment illustrated, the flexure members 31-34 are identical and include integrally formed flexure straps 36 and 38 (herein a pair each), formed by apertures 36A and 36B. The flexure straps 36 and 38 can be considered substantially planar. The flexure straps 36 and 38 are located on opposite sides of each longitudinal axis 21A-24A and join the corresponding radial member 21B-24B to the annular ring 16. As illustrated recesses 47 can be provided to make the flexure straps 36 and 38 more compliant.

It should be noted that although apertures 36A and 38A are depicted as being circular other shapes (diamond, square, rectangular, oval, etc.) can be used.

The radial members 21B-24B and flexure members 31-34 are formed in part by isolation apertures 37 provided on either side of axes 21A-24A that extend generally parallel to the axis 15. In addition, an isolation slot 39 is disposed radially outward from apertures 37 to further define the surfaces of the radial members 21B-24B and flexure members 31-34 furthest from axis 15. Apertures 41A and 41B provided in ring 16 are aligned with apertures 36A and 38B, respectively, due to the machining process for forming apertures 36A and 38A. In other words, flexure straps 36 and 38 are conveniently formed by machining ring 16 to form apertures 41A and 41B and then apertures 36A and 36B. Apertures 41A and 41B also provide access for mounting sensors such as strain gauges on the flexure straps 36 and 38, if desired.

In addition, each aperture 37 is connected by an isolation slot 41 to an adjacent sensor assembly 20, or as illustrated to a similar aperture of an adjacent load carrying assembly 29 if present, in order to isolate ring 14 from ring 16, but for the presence of radial members and flexure members in sensor assemblies 20, and assemblies 29 if provided.

The sensor assemblies 20 are adapted to receive sensors of any known type for detecting stress and/or strain therein. In the embodiment illustrated, sensors 30 comprise strain gauges disposed on or operably coupled to the flexure straps 36 and 38. The sensors 30 can be mounted on or operably coupled to the inner surfaces of the apertures 36A and 38A, which generally protect the sensors 30 (although mounting or operably coupled to the outer surfaces of straps 36 and 38 could also be feasible). Each sensor assembly 20 is generally sensitive in 2 orthogonal axes. In the embodiment illustrated, each sensor assembly 21-24 is configured so as to be sensitive for loads applied along the Y or central axis 15. In addition, sensor assemblies 21 and 23 are sensitive for loads applied along the Z-axis 19, while sensor assemblies 22 and 24 are sensitive for loads applied along the X-axis 17.

FIGS. 3A, 3B, 3C and 4 illustrate location and connection of the strain gauges into eight Wheatstone bridges. FIG. 3A illustrates portions of ring 16 for each of the sensor assemblies 21-24 in order to show location of the strain gauges attached thereto. However, it should be noted that two views of each ring portion are shown for purposes of understanding the mounting location of the strain gauges. One view is provided to illustrate a first set of strain gauges 50 that form a first sensing circuit, while a second view is provided to illustrate a second set of strain gauges 60 that form a second sensing circuit. Thus, in the illustrated embodiment, each aperture 36A and 38A includes six gauges mounted therein, but two views are provided in order to clearly depict their location for each sensing circuit.

Referring to FIG. 4, Wheatstone bridge 50A illustrates connection of the strain gauges 50 in the first sensing circuit to sense loads along the Y-axis 15 for sensor assembly 22. Eight strain gauges identified as “C1”, “C2”, “C3”, “C4”, “T1”, “T2”, “T3” and “T4” are connected as a single Wheatstone bridge. In an alternative configuration, strain gauges C1, C2, T1 and T2 can be connected in one Wheatstone bridge, while strain gauges C3, C4, T3 and T4 can be connected in another Wheatstone bridge, wherein output signals therefrom are electrically combined or processed so as to realize a signal indicative of loads at sensor assembly 22 with respect to the Y-axis 15. Strain gauges 50 at sensor assemblies 21, 23 and 24 are similarly connected as described with respect to sensor assembly 22.

Also with respect to sensor assembly 22, strain gauges 60 are connected in a Wheatstone bridge 60A to form the second sensing circuit that provides a signal indicative of loads along the X-axis 17. The strain gauges 60 of sensor assembly 24 are similarly connected to provide a signal indicative of loads along the X-axis 17. Likewise, the strain gauges 60 of sensor assemblies 21 and 23 are similarly connected but each provide a signal indicative of loads along the Z-axis 19.

FIGS. 3B and 3C illustratively show location of the strain gauges for set 50 or set 60 on the flexure straps 36 or 38 in that the strain gauges are mounted on the neutral axis thereof. Location of the strain gauges on the neutral axis and as illustrated in FIG. 3A minimizes cross-talk for the two-axis sensitivity of each sensor assembly 21-24. In other words, for loads along the Y-axis 15 the stress at each of the locations of strain gauges 50 is concentrated or high, while the stress at each of the locations of strain gauges 60 is low. Likewise for loads along the Z-axis 19 for sensor assemblies 21 and 23, or for loads along the X-axis 17 for sensor assemblies 22 and 24, the stress at the each of the locations of strain gauges 50 is low, while the stress at each of the locations of strain gauges 60 is concentrated or high. Thus, although all the sensors 30 are operably coupled to the same flexure straps 36 and 38 for each sensor assembly 21-24, the behavior of the flexure straps 36 and 38 and the location of the sensors provide a two-axis sensor assembly or load cell with favorable cross-talk characteristics. Both the load cell body (a single flexure element having at least two flexure straps joined to two members) and also the load cell body with suitable sensing devices, each comprise further aspects of the present invention.

Although sensors 30 are mounted conventionally to provide an output signal indicative of stresses in the flexure members 31-34, and in particular straps 36 and 38, such as compression and tension in the form of a change in resistance, other forms of sensing devices such as optically based sensors or capacitively based sensors can also be used to sense changes in stress or any other characteristic that exhibits a change, such as displacement, due to loading of the sensor assemblies 21-24.

In the embodiment illustrated, the load cell 10 provides eight signals as described above. The eight signals are then transformed to provide forces and moments about the axis of the coordinate system 15. Specifically, force along the X-axis 17 is measured stresses created in sensor assemblies 22 and 24. This can represented as:
Fₓ=Fₓ₁+Fₓ₂;
where the outputs Fₓ₁ and Fₓ₂ are obtained as indicated in FIG. 4 from sensor assemblies 22 and 24, respectively.

Similarly, force along the Z-axis 19 is measured as stresses created in the sensor assemblies 21 and 23. This can be represented as:
F_{z}=F_{z1}+F_{z2};
where the outputs Fz₁ and F_{z2} are obtained as indicated in FIG. 4 from sensor assemblies 21 and 23, respectively.

Force along the Y-axis 15 is measured as axial tension/compression created in sensor assemblies 21-24. This can be represented as:
F_{y}=F_{y1}+F_{y2}+F_{y3}+F_{y4}
where the outputs F_{y1}, F_{y2}, F_{y3} and F_{y4} are obtained as indicated in FIG. 4 from sensor assemblies 22, 23, 24 and 21, respectively.

An overturning moment about the X-axis 17 is measured as axial tension/compression forces created in sensor assemblies 22 and 24 from the opposed forces applied thereto. This can be represented as:
Mₓ=F_{y1}−F_{y3}.
Note, that the outputs indicative of F_{y2} and F_{y4} are effectively zero.

Likewise, an overturning moment about the Z-axis 19 is measured as axial tension/compression created in sensor assemblies 21 and 23 from the opposed forces applied thereto. This can be represented by:
M_{z}=F_{y2}−F_{y4}.
Note that for a moment about the Z-axis 19, the outputs F_{y1} and F_{y3} are zero.

An overturning moment about the Y-axis 15 is measured as principal strains due to stresses created in sensor assemblies 21-24. This can be represented as:
M_{y}=(Fₓ₁−Fₓ₂)+(F_{z1}−F_{z2})

It should be understood that the number of sensors 30 and the number of sensing circuits can be reduced if measured forces and moments of less than six degrees of freedom is desired.

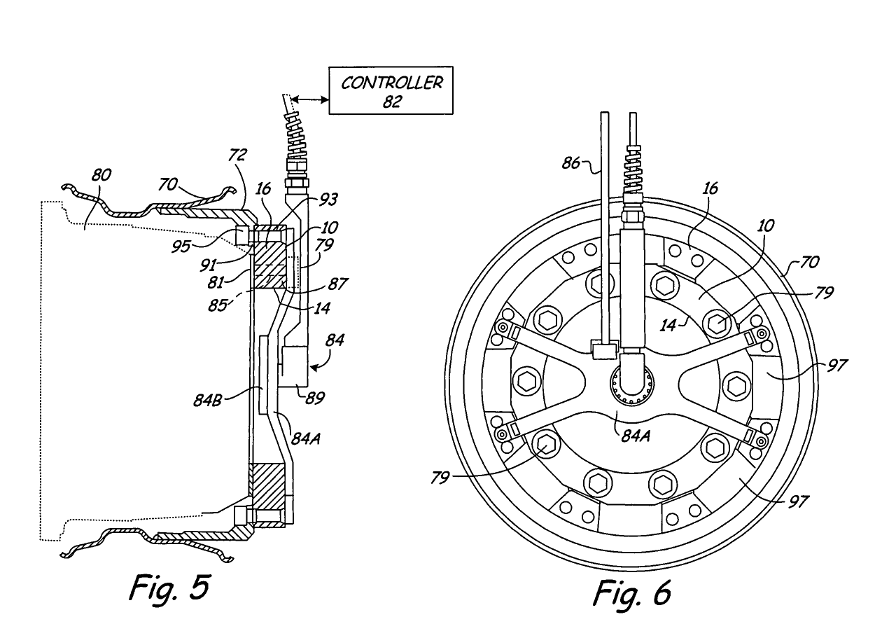

The load cell 10 is particularly well-suited, although not limited to, measuring the force and moment components of a rolling wheel. Referring to FIGS. 5 and 6, the load cell 10 is illustrated as being connected in the load path from a vehicle spindle 80 to a wheel rim 70. In effect, the load cell 10 replaces a center portion of the rim 70 connecting the spindle 80 to the tire interface.

The ring 14 is secured to the vehicle spindle 80. The vehicle spindle 80 includes a set of mounting bolts 85 that are generally adapted to receive a typical rim or wheel. The ring 14 includes a set of mounting apertures 87 extending parallel to the axis 15 that are adapted to mate with the mounting bolts 85. The ring 14 is connected to the spindle 80 with fasteners 79 that mate onto the bolts 85. In the example shown, the fasteners 79 comprise nuts that include internal screw threads that mate with the bolts 85. A thermal isolator 81 can be provided between the rim 80 and the load cell 10 to minimize heat transfer from the spindle 80.

The ring 16 is secured to the vehicle rim 70 with an extending rim flange 72 joined to the rim 70 or formed integral therewith from a single unitary body. The load cell 10 mounts to rim flange 72. The rim flange 72 includes a set of mounting apertures 91 adapted to align with mounting apertures 93 on the ring 16. The rim flange 72 is adapted to be attached to the second annular ring 16 with fasteners, such as bolts 95 that extend through the mounting apertures 91 and into aligned threaded mounting apertures 93 of the ring 16. In one example, the rim flange 72 is connected to the ring 16 with 16 bolts 95 in eight groups of two bolts.

It should be noted, the load cell 10 can also include raised portions (not explicitly shown) that extend slightly above the surface of the ring 14 to concentrate stresses proximate to each mounting aperture 87. Similar raised portions can be provided on the ring 16 proximate to mounting apertures 93 for mounting the load cell 10 to rim flange 72.

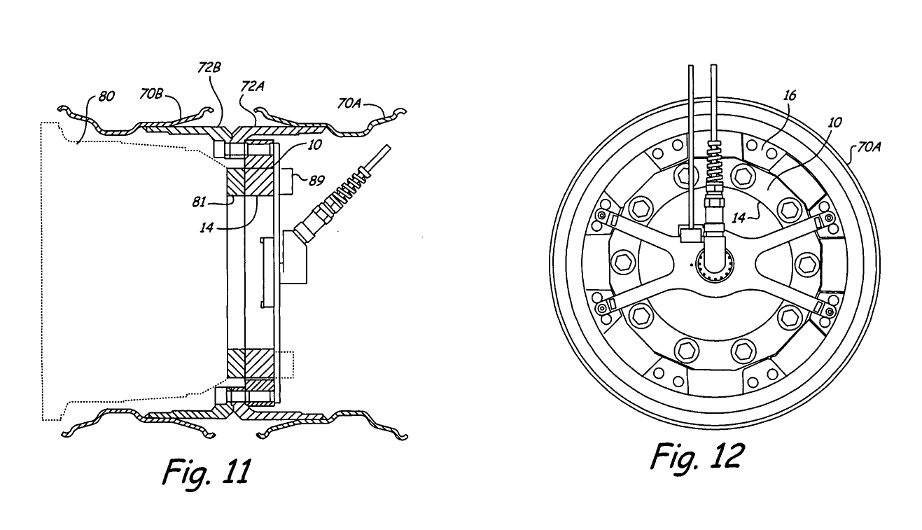

FIGS. 11 and 12 illustrate an embodiment where load cell 10 is mounted in a manner similar to that described above in the load path from spindle 80 and two vehicle rims 70A and 70B joined together with flanges 72A and 72B. The flanges 72A and 72B can be formed integral from a single unitary body with or without rims 70A and/or 70B.

Referring back to FIGS. 5 and 6, a controller 82 provides power to and receives outputs from the sensors 30 through a slip ring assembly 84 if the tire rim 70 rotates or partially rotates. The controller 82 calculates, records and/or displays the force and moment components measured by the load cell 10.

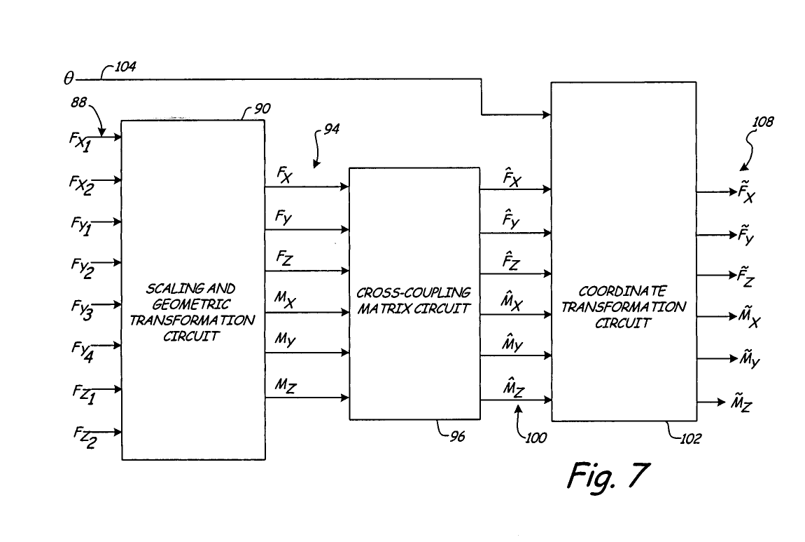

The slip ring assembly 84 includes a slip ring bracket 84A that attaches to ring 16. The slip ring assembly 84 also includes an anti-rotate assembly 86 and an encoder 89. The anti-rotate assembly 86 prevents the encoder 89 from rotating about the axis 15. Sensors 30 are connected to conductors that are carried in passageways in the slip ring bracket 84A to the encoder 89. The encoder 89 provides an angular output signal to the controller 82 indicative of the angular position of the load cell 10. An power/amplifier circuit 84B provides power to each of the Wheatstone bridge circuits through the slip ring assembly 84 and receives the output signals 88 (FIG. 7) therefrom, which are amplified and provided to controller 82. Covers 97 can be provided on both sides of the load cell 10 proximate each of the sensor assemblies 20, and assemblies 29 if present, in order to protect the components thereof and sensors 30.

FIG. 7 illustrates generally operation performed by the controller 82 to transform the output signals 88 received from the individual sensing circuits on the sensor assemblies 21-24 to obtain output signals 108 indicative of force and moment components with respect to six degrees of freedom in a static orthogonal coordinate system. As illustrated, output signals 88 from the sensing circuits are received by a scaling and geometric transformation circuit 90. The scaling and geometric transformation circuit 90 adjusts the output signals 88 to compensate for any imbalance between the sensing circuits. Circuit 90 also combines the output signals 88 according to the equations given above to provide output signals 94 indicative of force and moment components for the orthogonal coordinate system.

A cross-coupling matrix circuit 96 receives the output signals 94 and adjusts the output signals so as to compensate for any cross-coupling effects. A coordinate transformation circuit 102 receives output signals 100 from the cross-coupling matrix circuit 96 and an angular input 104 from an encoder or the like. The coordinate transformation circuit 102 adjusts the output signals 100 and provides output signals 108 that are a function of a position of the load cell 10 so as to provide force and moment components with respect to a static orthogonal coordinate system.

FIG. 8 illustrates the scaling and geometric transformation circuit 90 in detail. High impedance buffer amplifiers 110A to 110H receive the output signals 88 from the slip ring assembly 84. In turn, adders 112A to 112H provide a zero adjustment while, preferably, adjustable amplifiers 114A to 114H individually adjust the output signals 88 so that any imbalance associated with physical differences such as variances in the wall thickness of the location of the sensors 30 on the sensor assemblies 21-24 or variances in the placement of the sensors 30 from assembly to assembly can be easily compensated. Adders 116A to 116H combine the output signals from the amplifiers 114A to 114H in accordance with the equations above. Adjustable amplifiers 118A to 118D are provided to ensure that output signals from adders 116A to 116D have the proper amplitude.

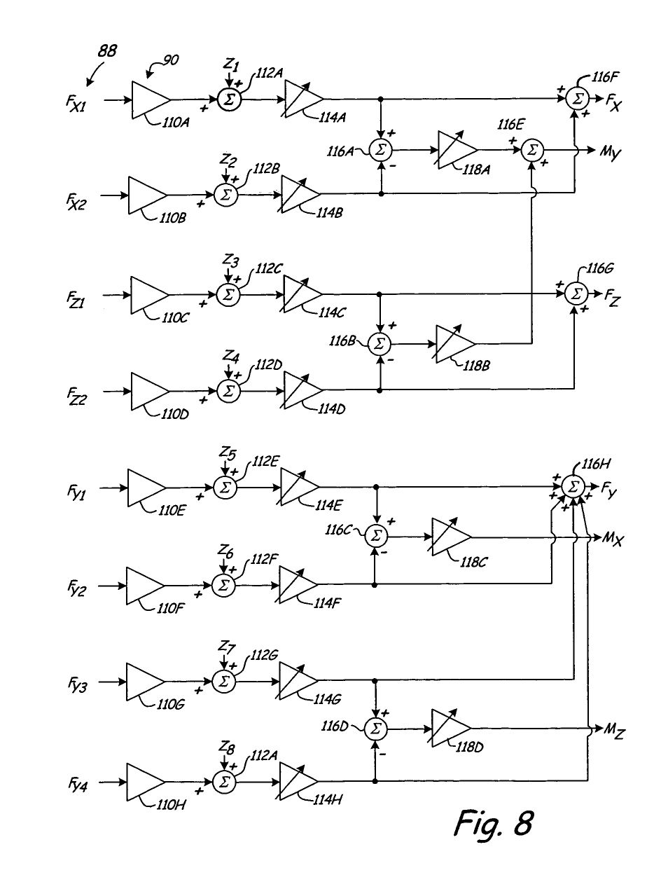

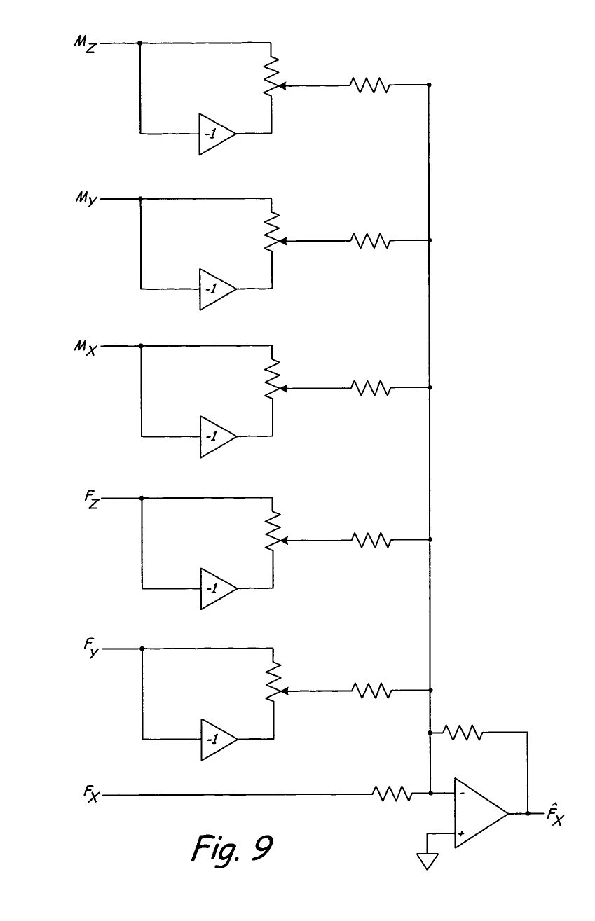

As stated above, cross-coupling compensation is provided by circuit 96. By way of example, FIG. 9 illustrates cross-coupling compensation for signal Fₓ. Each of the other output signals F_{y}, F_{z}, Mₓ, M_{y}, and M_{z} are similarly compensated for cross-coupling effects.

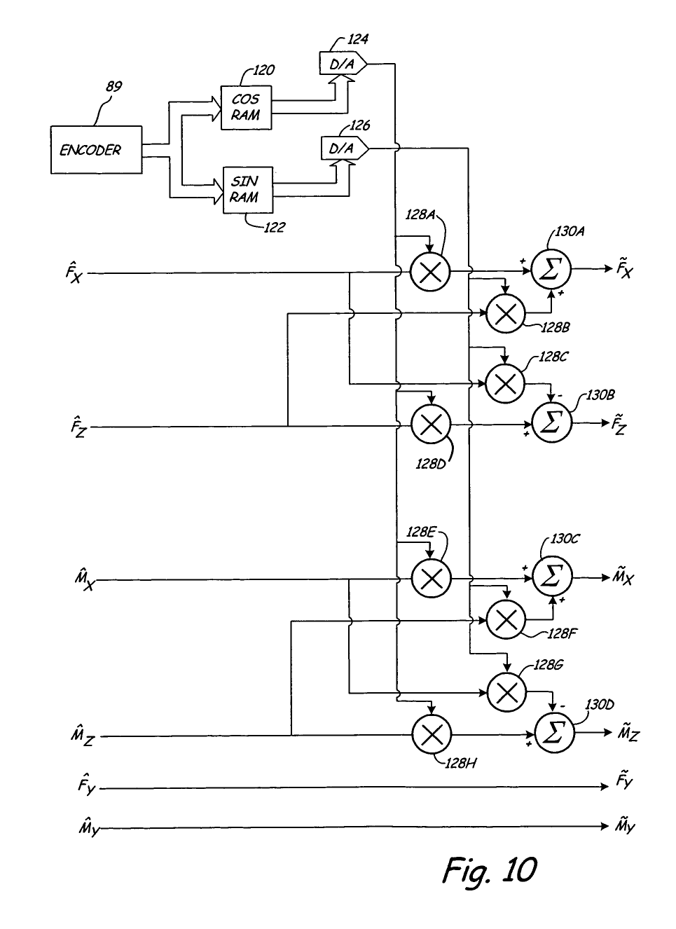

FIG. 10 illustrates in detail the coordinate transformation circuit 102. The encoder 89 provides an index for sine and cosine digital values stored in suitable memory 120 and 122 such as RAM (Random Access Memory). Digital to analog converters 124 and 126 received the appropriate digital values and generate corresponding analog signals indicative of the angular position of the load cell 10. Multipliers 128A to 128H and adders 130A to 130D combine force and moment output signals along and about the X-axis and the Z-axis so as to provide force and moment output signals 108 with respect to a static orthogonal coordinate system.

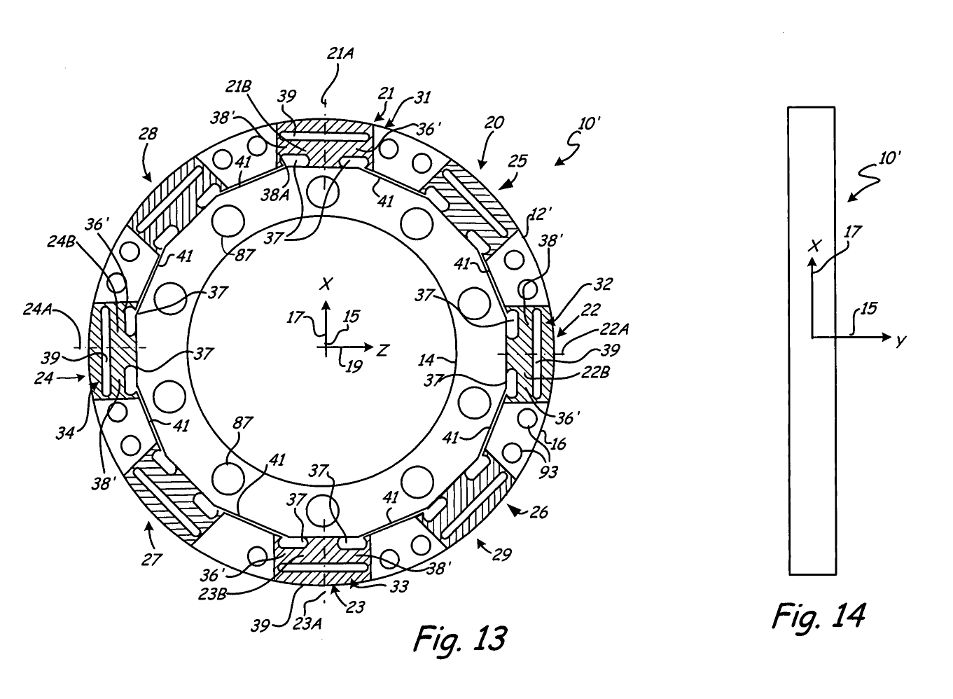

FIGS. 13 and 14 illustrate a second embodiment of a load cell 10′. Load cell 10′ includes a body 12′ that is integral formed from a single unitary body. Many of the structures of body 12′ are similar to body 12 above and accordingly the same numbers have been used. However, as further illustrated in FIGS. 15B and 15C flexure elements 36′ and 38′ are planar structures lacking the apertures of the previous embodiment.

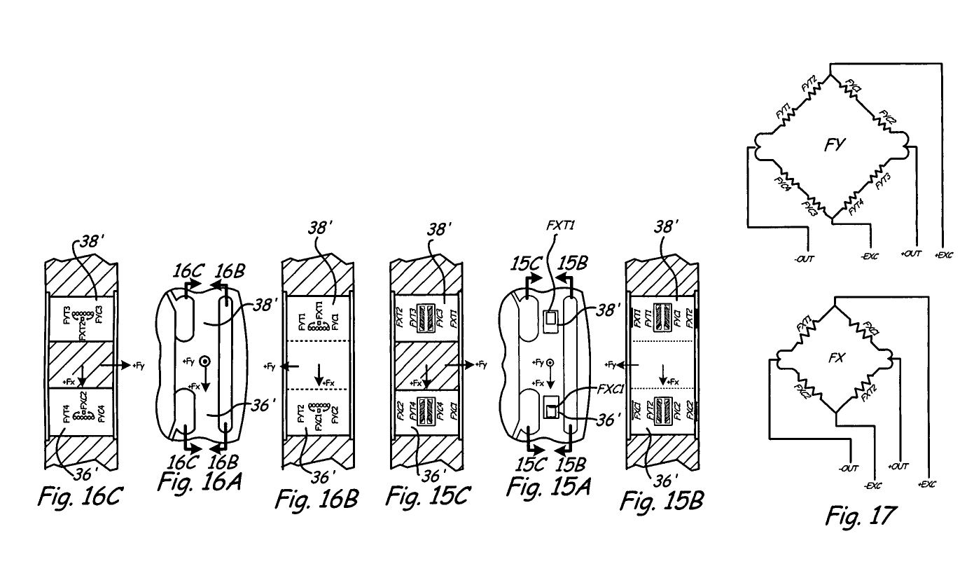

As in the previous embodiment, load cell 10′ have identical two-axis, sensor assemblies one of which is illustrated in FIG. 15A. Sensing devices such as strain gauges(although other types can be used) are used to measure stress and/or strain in the flexure members 36′, 38′. FIGS. 15A, 15B , 15C and 17 illustrated location on the sensor assembly and the corresponding Wheatstone bridges, where “FX” represents sensing forces in the X-direction (force in the z-direction is similarly achieved on other sensor assemblies), “FY” represents sensing forces in the Y-direction, “T” represents “tension”, “C” represents “compression”, and “1”, “2”, “3” and “4. FIGS. 16A, 16B and 16C illustrate an alternative configuration and also corresponds to FIG. 17. As with the previous embodiment, eight bridges can be used on four sensor assemblies.

Although the present invention has been described with reference to preferred embodiments, workers skilled in the art will recognize that changes may be made in form and detail without departing from the spirit and scope of the invention. For instance, in another embodiment, the position of the radial members and flexures can be reversed in that the radial members can secured to the ring 16 and where each flexure member joins the radial member to the ring 14.

What is claimed is:

1. A load cell suitable for transmitting forces and moments in a plurality of directions, the load cell comprising:
an integral assembly being formed from a single unitary body and having:
a first ring member and a second ring member, each ring member having a central aperture centered on a reference axis; and
at least three sensor assemblies, each sensor assembly comprising a stiff member attached to one of the rings and extending therefrom to the other radially from the reference axis, and a flexure assembly joining a remote end of each member to the other ring member; and
sensing devices disposed on each of the flexure assemblies configured to sense strain therein.

2. The load cell of claim 1 wherein each flexure assembly comprises two flexure elements joining the remote end of each member to the other ring, wherein the flexure elements are on opposite sides of a radially oriented axis of each stiff member, the sensing devices being disposed on each of the flexure elements.

3. The load cell of claim 2 wherein each flexure element includes an aperture to form a pair of flexure straps.

4. The load cell of claim 3 wherein the sensing devices are disposed on an inner surface of each aperture.

5. The load cell of claim 4 wherein one of the ring members includes apertures aligned the apertures of the flexure elements.

6. The load cell of claim 5 wherein the first ring member comprises an inner ring member and the second ring member comprises an outer ring member, and wherein each of the stiff members is directly coupled to the inner ring member and each flexure assembly is disposed between each stiff member and the outer ring member, and wherein the apertures in said one of the ring members comprise apertures in the outer ring member.

7. The load cell of claim 6 wherein the sensing devices are disposed on each flexure assembly so as to sense forces in two orthogonal directions.

8. The load cell of claim 7 and further comprising a plurality of load carrying assemblies wherein a load carrying assembly is disposed between two successive sensor assemblies, each of the load carrying assemblies having a construction similar to the sensor assemblies in that each load carrying assembly includes the stiff member attached to one of the rings and extending therefrom to the other radially from the reference axis, and the flexure assembly joining a remote end of each member to the other ring member.

9. The load cell of claim 8 wherein the flexure assembly of each load carrying assembly is similar in construction to the flexure assemblies of the sensor assemblies in that each of the flexure assemblies of the load carrying assemblies comprises flexure straps.

10. The load cell of claim 1 and further comprising a plurality of load carrying assemblies wherein a load carrying assembly is disposed between two successive sensor assemblies, each of the load carrying assemblies having a construction similar to the sensor assemblies in that each load carrying assembly includes the stiff member attached to one of the rings and extending therefrom to the other radially from the reference axis, and the flexure assembly joining a remote end of each member to the other ring member.

11. The load cell of claim 1 wherein the sensing devices are disposed on each flexure assembly so as to sense forces in two orthogonal directions.

12. A load cell body suitable for transmitting forces and moments in a plurality of directions, the load cell comprising:
an integral assembly being formed from a single unitary body and having:
a first ring member and a second ring member, each ring member having a central aperture centered on a reference axis; and
at least three sensor assemblies, each sensor assembly comprising a stiff member attached to one of the rings and extending therefrom to the other radially from the reference axis, and a flexure assembly joining a remote end of each member to the other ring, each flexure assembly comprising two flexure elements joining the remote end of each member to the other ring, wherein the flexure elements are on opposite side of an axis of each member, and wherein each flexure element includes an aperture to form a pair of flexure straps.

13. The load cell body of claim 12 and further comprising a plurality of load carrying assemblies wherein a load carrying assembly is disposed between two successive sensor assemblies, each of the load carrying assemblies having a construction similar to the sensor assemblies in that each load carrying assembly includes the stiff member attached to one of the rings and extending therefrom to the other radially from the reference axis, and the flexure assembly joining a remote end of each member to the other ring member.

14. The load cell body of claim 13 wherein the flexure assembly of each load carrying assembly is similar in construction to the flexure assemblies of the sensor assemblies in that each of the flexure assemblies of the load carrying assemblies comprises flexure straps.
